(19) United States
(12) Patent Application Publication
(10) Pub. No.: US 2014/0001853 A1
(43) Pub. Date: Jan. 2, 2014

(54) CHARGER AND POWER SUPPLY SYSTEM

(71) Applicants: Hiroyuki Hanawa, Hitachinaka (JP); Shinji Watanabe, Hitachinaka (JP); Haruhisa Fujisawa, Hitachinaka (JP); Kazuhiko Funabashi, Hitachinaka (JP); Takao Aradachi, Hitachinaka (JP)

(72) Inventors: Hiroyuki Hanawa, Hitachinaka (JP); Shinji Watanabe, Hitachinaka (JP); Haruhisa Fujisawa, Hitachinaka (JP); Kazuhiko Funabashi, Hitachinaka (JP); Takao Aradachi, Hitachinaka (JP)

(73) Assignee: Hitachi Koki Co., Ltd., Tokyo (JP)

(21) Appl. No.: 13/984,784

(22) PCT Filed: Mar. 23, 2012
(86) PCT No.: PCT/JP2012/002051

§ 371 Date: Aug. 9, 2013

(30) Foreign Application Priority Data
Mar. 25, 2011 (JP) 2011-067192

(51) Int. Cl. H02J 4/00

(52) U.S. Cl. CPC H02J 4/00
USPC 307/38

(57) ABSTRACT

A charger includes: a connection portion configured to connect either one of a battery pack and an electric device as an object device, the electric device being configured to generate a power supply related signal related to power supply thereto; a determination unit configured to determine which the battery pack or the electric device is the object device which is connected to the connection portion; and a control unit configured to charge the batter pack through the connection portion when the battery pack is connected to the connection portion, the control unit configured to control power supply to the electric device through the connection portion in accordance with the power supply related signal.

### TECHNICAL FIELD

The present invention relates to a charger for charging a battery pack and a power supply system using the charger.

### BACKGROUND ART

A charger for battery pack typically has a function of charging a NiCad battery pack, a nickel-hydride battery pack, or a lithium-ion battery pack but does not have a function other than the charging function. On the other hand, there is available a multi-function charger that has a connector separate from a battery mounting portion to which a battery pack is attached for charging. In this configuration, the connector can be connected with, e.g., a cordless tool, while the battery mounting portion is used exclusively for battery pack charging.

### DISCLOSURE OF INVENTION

### Solution to Problem

The charger is often carried by a user, together with the battery pack, for recharging of the battery pack. However, the user has no occasion to use the charger while the battery pack is attached to, e.g., an electric tool. Thus, application of the charger is very limited.

The present invention has been made in view of the above situation. An object of the present invention is to provide a charger that can effectively be used for various applications.

The present invention features a charger comprising: a single connection portion configured to selectively connect either one of a battery pack and an electric device as an object device.

Preferably, the charger further comprises: a determination unit configured to determine which the battery pack or the electric device is the object device which is connected to the connection portion; and a control unit configured to charge the batter pack through the connection portion when the battery pack is connected to the connection portion, the control unit being configured to control power supply to the electric device through the connection portion when the electric device is connected to the connection portion.

Preferably, the electric device is configured to generate a power supply related signal related to power supply thereto. The control unit is configured to control power supply to the electric device through the connection portion in accordance with the power supply related signal when the electric device is connected to the connection portion.

Preferably, the determination unit determines whether the object device is able to communicate with the control unit, when the object device is communicable with the control unit, the determination unit determines that the electric device is connected to the connection portion, and when the object device is not communicable with the control unit, the determination unit determines that the battery pack is connected to the connection portion.

Preferably, the determination unit determines that the object device is communicable with the control unit when the control unit receives device information from the object device.

Preferably, the control unit is configured to transmit charger information to the electric device and the control unit is configured to receive the power supply related signal which has been modified in accordance with the charger information by the electric device.

The present invention features a power supply system comprising: an electric device having a predetermine function; and a charger configured to supply power a battery pack and an electric device selectively, the charge comprising a single connection portion configured to selectively connect either one of a battery pack and an electric device as an object device.

Preferably, the charger further comprises: a determination unit configured to determine which the battery pack or the electric device is the object device; a control unit configured to charge the battery pack through the connection portion when the battery pack is connected to the connection portion, the control unit being configured to control power supply to the electric device through the connection portion when the electric device is connected to the connection portion.

Preferably, the electric device is configured to generate a power supply related signal related to power supply thereto. The control unit is configured to control power supply to the electric device through the connection portion in accordance with the power supply related signal when the electric device is connected to the connection portion.

Preferably, the determination unit determines whether the object device is able to communicate with the control unit, when the object device is communicable with the control unit, the determination unit determines that the electric device is connected to the connection portion, and when the object device is not communicable with the control unit, the determination unit determines that the battery pack is connected to the connection portion.

Preferably, the determination unit determines that the object device is communicable with the control unit when the control unit receives device information from the object device.

Preferably, the control unit is configured to transmit charger information to the electric device, and the electric device modifies the power supply related signal in accordance with the charger information to the control unit and then transmits the modified power supply related signal to the charger.

According to the above configuration, when the battery pack is connected to the single connection portion, the controller supplies power from the charger to the battery pack through the connection portion so as to charge the battery pack. On the other hand, when the electric device is connected to the same connection portion of the charger, the charger supplies power to the electric device through the connection portion for the operation of the electric device. When the charger receives the power supply related signal from the electric device through the connection portion, the charger determines that the electric device is connected to the connection portion. The controller then performs power supply control for the electric device based on the received power supply related signal. For example, when the electric device outputs a signal concerning the input voltage and input power as the power supply related signal and instructs the charger to start power supply, the controller starts the power supply from the charger to the electric device under a condition based on the received power supply related signal. Then, when the electric device outputs, to the charger, a signal instructing the charger to stop the power supply as the power supply related signal, the controller stops the power supply from the charger to the electric device.

### Advantageous Effects of Invention

According to the present invention, the charger has the single connection portion for charging the battery pack, the connection portion being connectable to the electric device. The charger for the battery pack can supply power to either one of the battery pack and the electric device through the single connection portion.

Thus, while the battery pack is not connected to the charger for charging, power from the charger can be utilized to use the electric device. Further, information required for the power supply to the electric device is input from the electric device in a form of the power supply related signal, thus eliminating the need for the charger to detect a specification of the electric device, which can simplify the configuration of the charger.

### BRIEF DESCRIPTION OF DRAWINGS

FIG. 1 is a view showing a charger according to an embodiment of the present invention.

FIG. 2A is a front view of a plug-in type of charger and a battery pack connected thereto.

FIG. 2B is a front view of a slide type of charger and a battery pack connected thereto.

FIG. 3 is a circuit diagram showing a charger and a battery pack.

FIG. 4 is a circuit diagram showing a charger and an electric device.

FIG. 5 is a view illustrating communication between an electric device and a charger.

FIG. 6 is a flowchart explaining operation of a charger.

FIG. 7A is a front view showing a plug-in type of charger and an electric fan connected thereto.

FIG. 7B is a front view showing a slide type of charger and an electric fan connected thereto.

FIG. 8 is a flowchart illustrating operation of a charger for power supply to an electric fan.

FIG. 9A is a front view showing a plug-in type of charger and a can cooler/warmer connected thereto.

FIG. 9B is a front view showing a slide type of charger and a can cooler/warmer connected thereto.

FIG. 10 is a flowchart illustrating operation of a charger for power supply to a can cooler/warmer.

### REFERENCE SIGNS LIST

10 Charger

18 Connection portion

24 Control circuit

30 Electric device

100 Battery pack

### BEST MODE FOR CARRYING OUT THE INVENTION

An embodiment of the present invention will be described below with reference to the accompanying drawings.

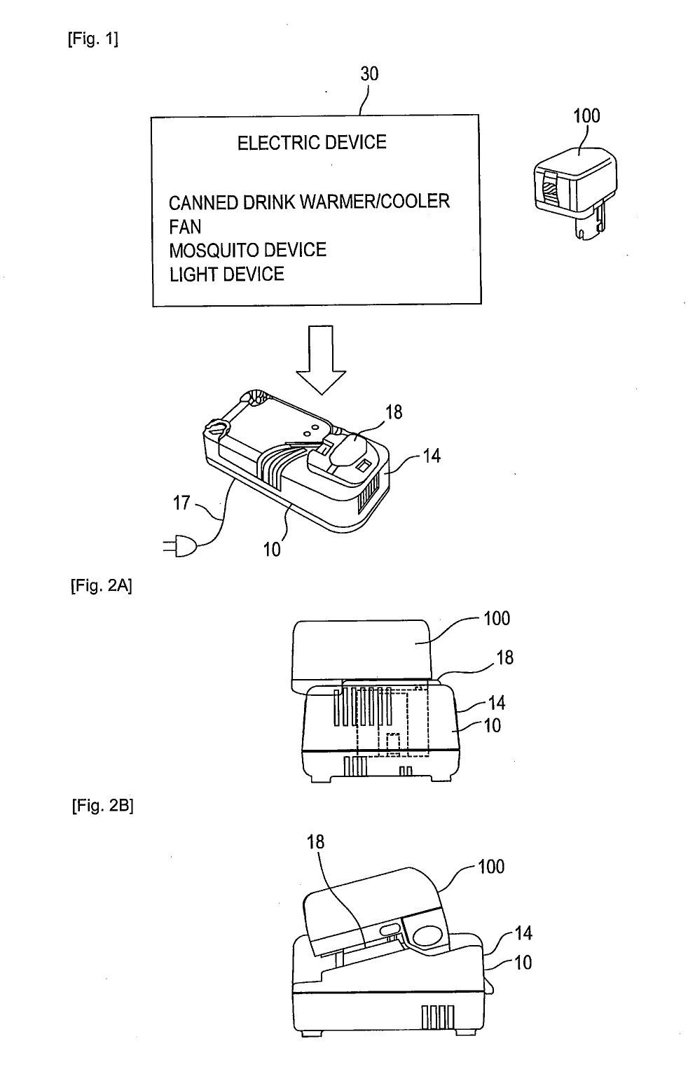

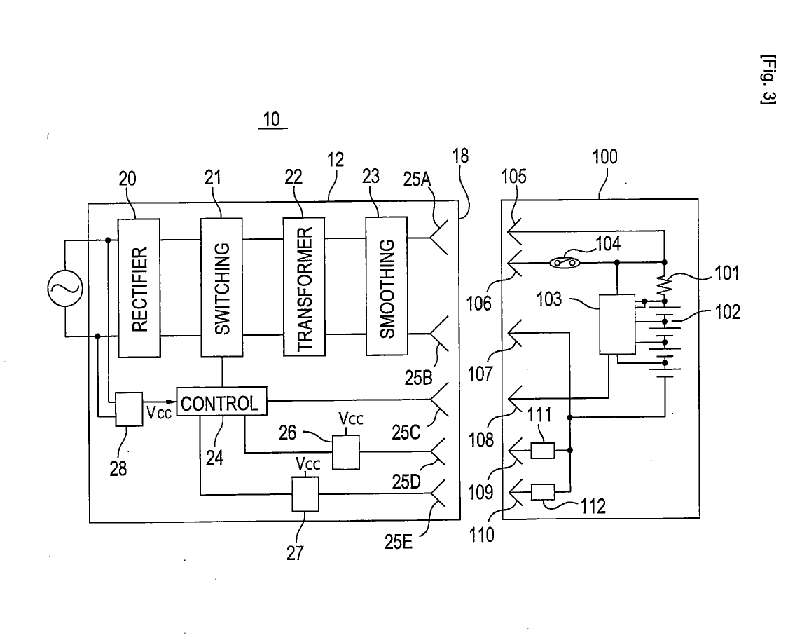

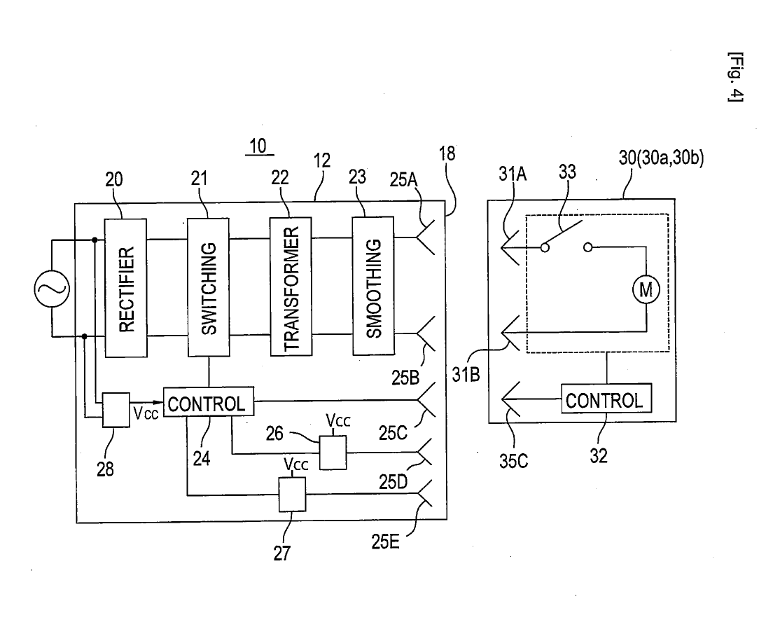

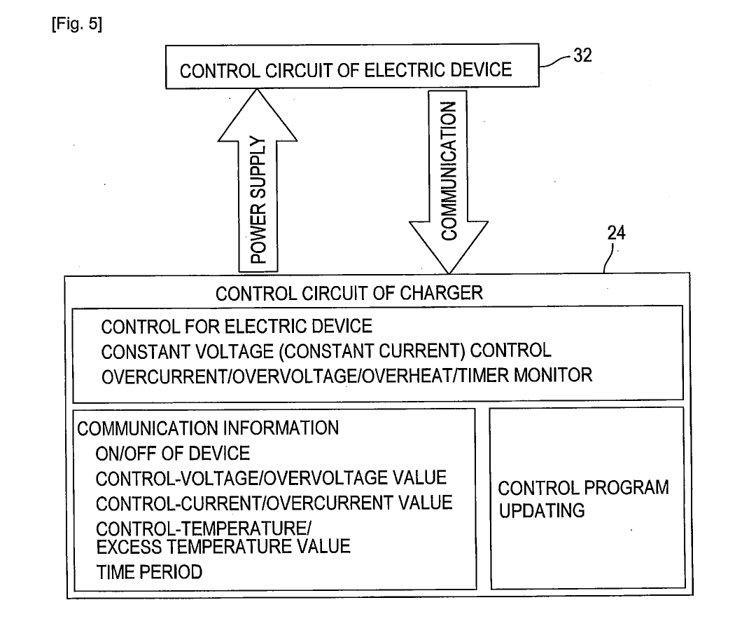

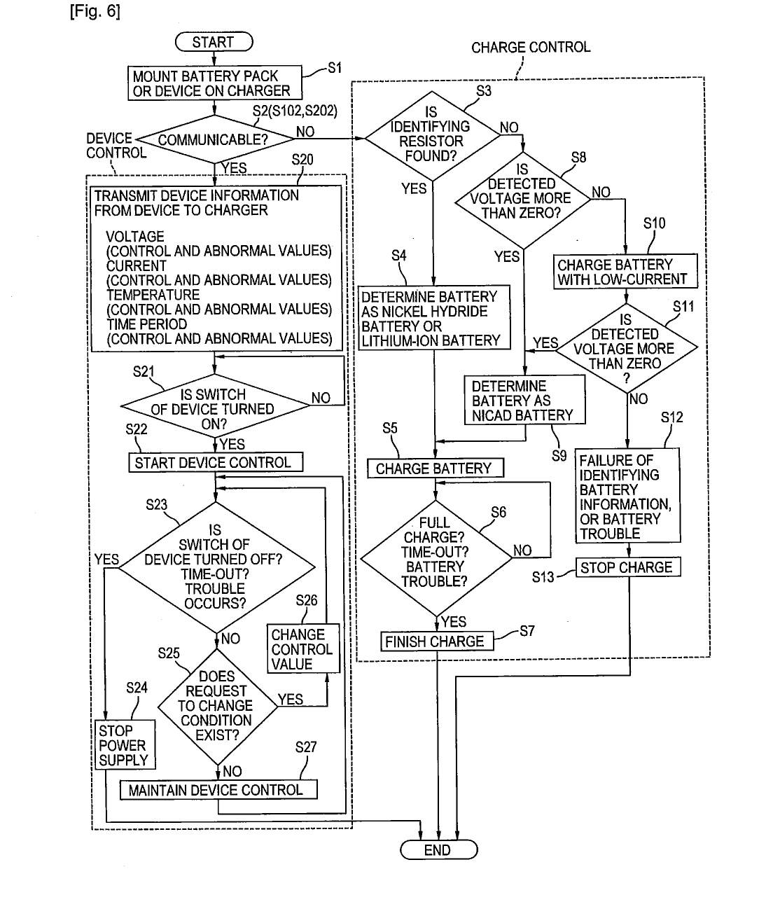

FIG. 1 illustrates a charger 10 for charging a battery pack 100. The charger 10 includes a main body 14 having a charge circuit 12 inside thereof, an electric cord 17 for connecting the main body 14 (the charge circuit 12) to a commercial power supply, and a connection portion 18 to which the battery pack 100 is electrically connected to the charge circuit 12. Generally, there are two types of charger by differences related to the structure of the connection portion 18: a plug-in type of charger having the connection portion 18 in which the battery pack 100 is plugged, as shown in FIG. 2A, and a slide type of charger having the connection portion 18 to which the battery pack 100 is slid, as shown in FIG. 2B.

FIG. 3 illustrates the circuit diagram of the charge circuit 12 of the charger 10. The charge circuit 12 includes, from a power-input side (left side in FIG. 2) to a power output side (right side in FIG. 2), a rectifier 20, a switching circuit 21, a transformer 22, and a smoothing circuit 23. Further, a control circuit 24 serving as a controller is connected to the switching circuit 21. The charge circuit 12 further includes a constant voltage circuit 28 for supplying a reference voltage Vcc (5V, for example) to the control circuit 24 from the commercial power supply. The output of the constant voltage circuit 28 is supplied to the control circuit 24, a battery pack identifying portion 26 described later and a temperature detecting portion 27 described later.

The rectifier 20 receives AC power from the commercial power supply through the electric cord 16. The rectifier 20 includes a full-wave rectifying circuit section and a smoothing capacitor (which are not illustrated) and smoothes and rectifies the AC power to output a DC power.

The switching circuit 21 includes MOSFETs (not illustrated) serving as switching elements and a PWM control IC (not illustrated) that controls the switching elements. The transformer 22 includes a high-frequency transformer (not illustrated). A primary side of the high-frequency transformer is connected to the switching elements of the switching circuit 21 in series, and a secondary side the high-frequency transformer is connected to the smoothing circuit 23. The PWM control IC of the switching circuit 21 includes a switching power supply IC that changes a drive pulse width for the switching element and adjusts an output voltage of the switching circuit 21.

The smoothing circuit 23 is a rectifying/smoothing circuit including the first diode (not illustrated) connected to the secondary side of the high-frequency transformer in series, the second diode (not illustrated) connected to the secondary side of the high-frequency transformer in parallel, a choke coil (not illustrated) connected in series to the first diode, and a smoothing capacitor (not illustrated) connected in parallel to the second diode.

The control circuit 24 detects an input voltage and an output voltage of the charge circuit 12 and current flowing in the charge circuit 12 and controls an output power such as an output voltage and an output current to be output from output terminals 25A and 25B. Further, the control circuit 24 controls the PWM control IC of the switching circuit 21 so that an output voltage of the smoothing circuit 23 becomes a predetermined value. The output terminals 25A and 25B are provided in the connection portion 18 to be electrically connected respectively to charging terminals 106 and 107 of the battery pack 100 connected to the connection portion 18.

The control circuit 24 is directly connected to a signal terminal 25C provided in the connection portion 18. The control circuit 24 is further connected to a battery pack identifying portion 26 and a temperature detecting portion 27, respectively. When the battery pack 100 is connected to the charger 10, the battery pack identifying portion 26 obtains information of the battery pack 100 (rated voltage of the battery pack 100, the type, number and serial/parallel connection of the battery cells) on the basis of the signals received through a terminal 25D provided on the connection portion 18, and sends the obtained information to the control circuit 24. When the battery pack 100 is connected to the charger 10, the temperature detecting portion 27 detects the temperature of the battery pack 100 on the basis of the signal received through a terminal 25E provided in the connection portion 18, and send the detected temperature to the control circuit 24. Thus, the control circuit 24 detects overcurrent, overvoltage, and/or overheat of the battery pack 100, measures charging time period, and performs other control required to charge the battery pack 100. And, the control circuit 24 performs a constant voltage control or a constant current control as a charge control for the battery pack 100.

Further, the control circuit 24 determines which one of the battery pack 100 or the electric device 30 is connected to the connection portion 18. For example, if the control circuit 24 is able to establish communication with the mounted device, in other words, if the control circuit 24 receives device information from the mounted device through the signal terminal 25C, the control circuit 24 determines that the device connected to the connection portion 18 is the electric device 30. In this case, the control circuit 24 receives power supply related signal through the terminal 25C from the electric device 30 as the device information. According to the power supply related signal, the control circuit 24 sets turning on and off power supply from the charge circuit 12 and supply electric power to the electric device 30.

Although any device is physically mounted to the connection portion 18, it sometimes happens that the control circuit 24 has not received device information from the mounted device within a predetermined time period from the time when the device was mounted. In this case, the control circuit 24 determines that the device connected to the connection portion 24 is the battery pack 100. And, the control circuit 24 performs a charge control to the battery pack 100. It should be noted that the battery pack 100 may have a control unit, and the control circuit 24 of the charger 10 can determines the connected device is the battery pack 100 by means of communication between the control circuit 24 of the charger 10 and the control unit of the battery pack.

If the electric device 30 is connected to the charger 10, the terminals 25D and 25E remain free from the connection to the device. Generally, if the charger does not receive output signals from the connected device through the terminals 25D and 25E, the control circuit 24 determines that the connection is failed and then stops the operation of the charger 10. However, in this embodiment, if the control circuit 24 determines that the electric device 30 is connected to the charger 10 in accordance with communication with the device, the charger 10 starts controlling the connected device. In this embodiment, if the control circuit 24 receives device information from the device through the terminal 25C, the charger maintains the operation without receiving any input signals through the terminal 25D and 25E.

As shown in FIG. 3, the battery pack 100 includes a plurality of battery cells connected in series 102 (hereinafter referred to as a “battery 102”), terminals 105, 106 and 107, Any one of Nickel-metal Hydride battery, Lithium ion battery, and Nickel Cadmium battery can be used as the battery 102 of the battery pack 100. The terminals 106 and 107 are provided at both ends of a charge path within the battery pack 100. When the battery 102 is recharged, the terminal 106 serves as a positive terminal and the terminal 107 as a negative terminal On the other hand, when the battery 102 is discharged, the terminal 107 serves as a negative terminal and the terminal 105 as a positive terminal The terminals 106 and 107 are electrically connected to output terminals 25A and 25B of the charger 10, respectively. When the battery pack 100 is connected to an electrically-driven power tool, the terminal 105 of the battery pack 100 is connected to a positive terminal of the power tool, and the terminal 107 of the battery pack 100 to a negative terminal of the power tool.

The battery pack 100 further includes a protection circuit 103 for protecting the battery 102, a current detecting resistor 101 for detecting current flowing in the battery 102, a thermal protector 104, an identifying unit 111, and a temperature detection unit 112. The thermal protector 104 is provided for protecting the charger 10 from an abnormally high temperature. To this effect, the thermal protector 104 interrupts the charge path when the battery 102 has reached an abnormally high temperature.

The identifying unit 111 has a resistor having a specific resistance indicative of a rated voltage of the battery pack 100, the type, number and serial/parallel connection of the battery cells. The identifying resistor 111 is connected to the battery pack identifying portion 26 of the charger 10 through the identifying terminal 109 of the battery pack 100 and the terminal 25D of the charger 10. In this case, the battery pack identifying portion 26 has a resistor connected to the reference voltage Vcc which is the output of the constant voltage circuit 28. The battery pack identifying portion 26 divides the reference voltage with the resistor of the battery pack identifying portion 26 and the identifying resistor 111 and applies the divided voltage to the control circuit 24 of the charger 10. Through the investigation of the resistance of the identifying resistor 111, the charger 10 can acquire information about rated voltage of the battery pack 100, the type, number and serial/parallel connection of the battery cells. It should be noted that the battery pack 100 containing a Nickel-metal Hydride battery or a Lithium ion battery generally has the identifying resistor 111 whereas most of the battery pack 100 containing a Nickel Cadmium battery does not have the identifying resistor 111. In this case, the charger 10 receives input signals through the terminal 25E and does not receive input signals through the terminal 25D. Accordingly, the charger 10 determines that the device connected to the charger 10 is a battery pack 100 containing a Nickel Cadmium battery.

The temperature detecting portion 112 includes a thermistor. When the thermistor 112 is connected to a temperature detecting portion 27 through a temperature terminal 110 of the battery pack 100 and a terminal 25E of the charger 10, the temperature detecting portion 27 outputs a relevant voltage to the control circuit 24 of the charger 10. The temperature detecting portion 27 has a resistor connected to the reference voltage Vcc which is an output of the constant voltage circuit 28. Accordingly, the temperature detecting portion 27 divides the reference voltage Vcc with the resistor of the constant voltage circuit 28 and the thermistor 112, and applies the divided voltage to the control circuit 24 of the charger 10. Generally, the thermistor 112 changes the resistance value according to the temperature. As a result, the divided voltage also changes the value. Thus, the charger 10 can acquire information about the temperature of the battery pack 100 by virtue of the thermistor 112.

In the embodiment of the invention, used in the battery pack 100 is a Lithium ion battery consisting of four Lithium ion battery cells connected in series. Each cell has a rated voltage of 3.6V and thus the rated voltage of the battery 102 is 14.4V. The protection circuit 103 monitors both the cell voltage and the level of the current flowing in the current detecting resistor 101. The protection circuit 103 outputs an abnormal signal to the charger 10 through the terminal 108 when the voltage across each battery cell exceeds a first predetermined value (4.2V, for example) indicating that the battery is in an overcharged condition, or the voltage across each battery cell falls below a second predetermined value (2.0V, for example) indicating that the battery is in an overdischarged condition, or the current flowing in each battery cell exceeds a third predetermined value (25A, for example) indicating an overcurrent flowing condition.

The electric device 30 is a small-sized electric device such as a can cooler/warmer, an electric fan, a mosquito repellent, a lighting device, or a radio. As illustrated in FIG. 4, the electric device 30 can be connected to the connection portion 18 of the charger 10 and has input terminals 31A and 31B to be connected respectively to the output terminals 25A and 25B of the charger 10. The electric device 30 further includes a signal terminal 35C which is connectable with the terminal 25C of the charger. The electric device 30 can be made operable by power which is supplied through the input terminals 31A and 31B. The electric device 30 has a control circuit 32 and a switch 33 that turns ON/OFF the operation thereof. The control circuit 32 includes a storing unit (not shown), and stores a voltage, a current, a temperature, an operating time, and a control program which are required for the operation of the electric device 30, as the power supply related signals. The control program refers to a program to be used for controlling the operation of the electric device 30.

When the electric device 30 is connected to the charger 10, the control circuit 32 outputs the voltage, the current, the temperature, the operating time, and/or the control program to the charger 10 through the terminal 35C. The electric device 30 further includes an operating panel (not shown) for changing the operating condition associated with the function. Accordingly, the electric device 30 can modify the voltage, the current, the temperature, the operating time, and/or the control program.

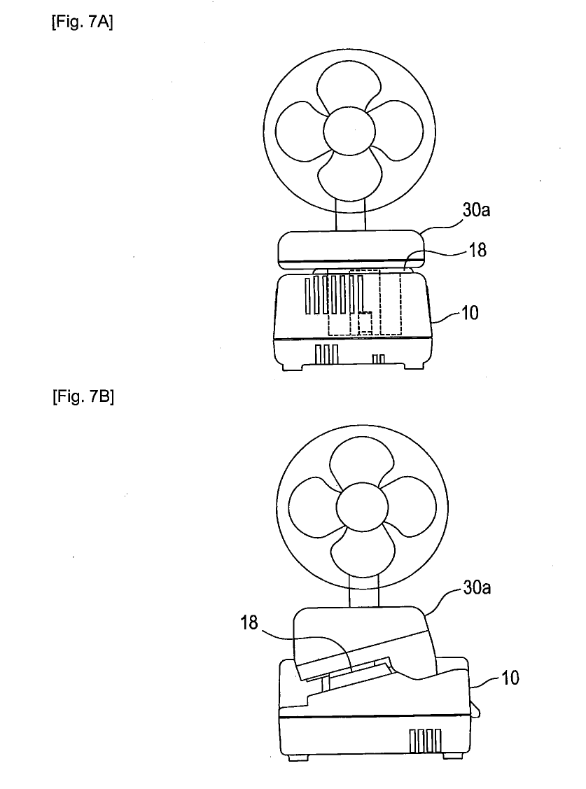

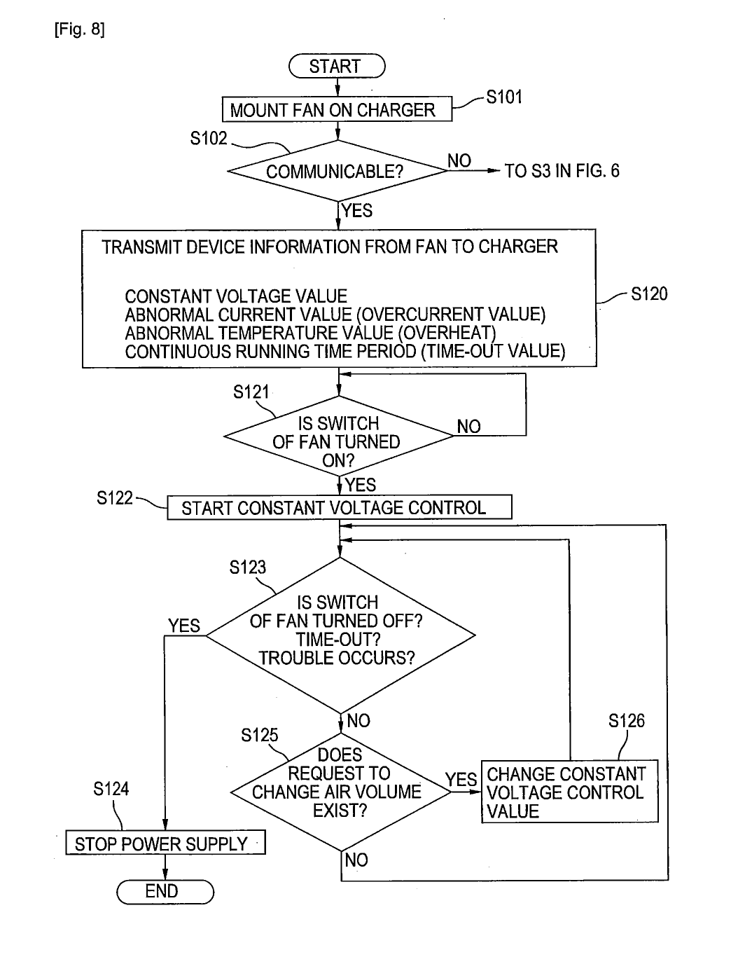

The following description will be made for the operation of the charger 10 with reference to FIG. 6.

Either one of the battery pack 100 and the electric device 30 is connected to the connection portion 18 of the charger 10 (step S1). In step S2, the control circuit 24 of the charger 10 determines whether the control circuit 24 establishes communication with the device mounted on the connection portion 18 (designated as a mounted device hereinafter). In step S2, if it is determined that the charger 10 can establish communication with the mounted device (S2: YES), the control circuit 24 determines that the mounted device is the electric device 30. On the other hand, if the communication with the mounted device is impossible (S2: NO), the control circuit 24 determines that the mounted device is the battery pack.

When communications with the mounted device cannot be established (S2: NO), the charger 10 starts the charge control of the battery pack 100. The routine proceeds to S3 where the control circuit 24 determines whether or not the identifying resistor 111 is detected. When the identifying resistor 111 is detected (S3: YES), the routine proceeds to S4 where determination is made as to whether the type of the battery contained in the battery pack 100 is the Nickel-metal Hydride battery or the Lithium ion battery.

On the other hand, when the identifying resistor 111 is not detected (S3: NO), the routine proceeds to S8 where the battery voltage is detected. When the battery voltage is detected (S8: YES), that is, when the detected voltage is not zero, determination is made in S9 that the type of the battery contained in the battery pack 100 is a Nickel Cadmium battery.

When the battery voltage is not detected (S8: NO), a small amount of current is flowed in the battery 102 to see if there is a voltage increase in the battery 102 (S11). If the battery voltage increases (S11: YES), the type of the battery contained in the battery pack 100 can be identified as the Nickel Cadmium battery (S9). On the other hand, if there is no substantial increase in the battery voltage notwithstanding the fact that a small amount of current is flowed in the battery 102 (S11: NO), determination is made so that the type of the battery contained in the battery pack 100 cannot be identified or the battery is in a malfunctioning state (S12), whereupon charging the battery 102 is terminated (S13).

When the type of the battery pack 100 is determined, in step S5, the charger 10 starts charging the battery pack 100. As to the charging of the battery pack 1, well-known constant-current charging for NiCad battery pack, a nickel-hydride battery pack or well-known constant-current and constant-voltage charging for lithium-ion battery pack) are performed. When the charge is started, in Step S6, the control circuit 24 determines whether the battery pack 100 has been fully charged, whether a predetermined time period has expired, or whether malfunction occurs in the battery pack 100. If the battery pack 100 is fully charged, the predetermined time period has expired, of the malfunction occurs in the batter pack 100 (S6: YES), the charger 10 terminates the charging of the battery pack 100 (step S7).

As is well-known, the full charge of the battery pack 100 is determined by detecting −delta V (for NiCad battery pack, a nickel-hydride battery pack) or by detecting a reduction of charging current to a value less than a predetermined value (for lithium-ion battery pack). During the charging, the control circuit 24 monitors a charging state (battery state) of the battery pack 100 by means of a known battery voltage detection means, a known charging current detection means, a known battery temperature detection means (which are not illustrated), and the like so as to detect the full charge or determine a charging abnormality.

On the other hand, in step S2, if the communication with the mounted device is established (S2: YES), in other words, if the control circuit 24 of the charger 10 receives a device signal from the mounted device within a predetermined time period from the finishing mounting the device onto the connection portion 18, the control circuit 24 determines that the mounted device is the electric device 30. The device signal includes a power supply related signal generated from the control circuit 32 of the electric device 30. The power supply related signal may include a voltage (a control value and an abnormal value), a current (a control value and an abnormal value), an operating time period (a control value and a time-out value). In Step 20, the control circuit 24 of the charger 10 communicates with the electric device 30 mutually, and then the control circuit 24 controls the charge circuit 12 on the basis of the power supply related signal received from the electric device 30.

If the charger 10 outputs charger information such as a maximum output current or a maximum output voltage to the electric device 30, the electric device 30 may modify the power supply related signal in accordance with the received charger information and then supply the modified power supply related signal to the charger 10. In this case, the electric device 30 can maximize the performance of the charger 10. It should be noted that a storage section is provided in the control circuit 24 of the charger 10 to stores the charger information.

Then, in step S21, when the switch 33 of the electric device 30 is tuned ON, the charger 10 starts power supply to the electric device 30 according to the power supply related signal (step S22). Then, if the switch 33 of the electric device 30 is turned OFF, an abnormality occurs in the electric device 30 in terms of the voltage, the current, or the temperature, or the predetermined time period has elapsed from the start of the power supply (S9: YES), the charger 10 stops the power supply to the electric device 30 (step S24).

On the other hand, if any one of turning off the switch 33 of the electric device 30; the abnormal condition related to the voltage, the current, or the temperature of the electric device 30; or the elapse of the predetermined time period does not happen (S23: NO), the process advances to S25. In Step S25, if any operating condition has been changed (S25: YES), the control circuit 24 changes the corresponding condition such as the input voltage, the current, the temperature, or the operating time period (Step 26). Then, the monitoring the operating condition of the electric device 30 is maintained (Step S23). If the operating condition is not changed (S25: NO), the power supply from the charger 10 to the electric device 30 with the current operating condition is maintained (Step S27). And, the monitoring the operating condition of the electric device 30 is maintained (Step S23).

The configuration in which not only the battery pack 100 but also the electric device 30 can be connected to the connection portion 18 of the charger 10 allows power supply from the charger 10 to the electric device 30, when the battery pack 100 is not connected to the charger 10.

Further, the battery pack 100 and the electric device 30 can be selectively mechanically connected to the connection portion 18 of the charger 10 to be electrically connected to the charge circuit 12 inside the charger 10. Accordingly, a single connection portion 18 is available for the charger 10 to achieve the multifunctionality, thereby reducing a size of the entire charger 10.

Further, the information required for the power supply to the electric device 30 is supplied from the electric device 30 to the charger 10 in a form of the power supply related signal. Thus, various signals such as an input voltage, an input current, temperature information, and an operating time period of the electric device 30, and control program therefor can be supplied to the charger 10, as the power supply related signal, which allows the charger 10 to perform power supply to the electric device 30 according to the type of the electric device 30 connected thereto.

Further, the charger 10 need not detect by itself the information required for the power supply to an external device, thereby eliminating a unit for information detection in the charger 10. As a result, the total number of components required in the charger 10 can be reduced, which results in manufacturing the charger 10 at lower cost.

The next description will be made for explaining the operation of the charger 10 when an electric fan as the electric device is connected to the charger 10, referring to FIGS. 7 and 8. Generally, there are two types of electric fan; one type is an electric fan 30a which is connectable with the plug-in type of charger 10, as shown in FIG. 7A, the other type is an electric fan 30a which is connectable with the slide type of charger 10, as shown in FIG. 7B. A difference between the two types of electric fan 30a is the structure of the connection portion 18. Both of the two types of electric fan 30a have the same operation.

The electric fan 30a is connected to the connection portion 18 of the charger 10 (step S101). In step S102, the control circuit 24 of the charger 10 determines whether the control circuit 24 establishes communication with the electric fan. In other words, if the control circuit 24 of the charger 10 receives a device signal from the electric fan 30a within a predetermined time period from the finishing mounting the electric fan 30a onto the connection portion 18, the control circuit 24 acknowledges that the communication with the electric fan 30a is established (S102: YES), and then determines that the electric fan 30a is connected to the charger 10. In case that the control circuit 24 fails to establish the communication with the electric fan 30a (S102: NO), this phenomenon means that the electric fan 30a might be broken or the battery pack might be connected to the charger 10. Accordingly, if the communication is not established (S102: NO), the procedure advances to Step S3 of the charge process.

The device signal received from the electric fan 30a includes a power supply related signal generated from the control circuit 32 of the electric fan 30a. The power supply related signal may include a constant voltage control value, an abnormal current value (an overcurrent value), an abnormal temperature value (overheat), or a continuous operating time period (a time-out value). In Step 120, the control circuit 24 of the charger 10 communicates with the electric fan 30a mutually, and then the control circuit 24 controls the charge circuit 12 on the basis of the power supply related signal received from the electric fan 30a. If the charger 10 outputs charger information such as a maximum output current or a maximum output voltage to the electric fan 30a, the electric fan 30a may modify the power supply related signal in accordance with the received charger information and then supply the modified power supply related signal to the charger 10. In this case, the electric fan 30a can maximize the performance of the charger 10.

Then, in step S121, when the switch 33 of the electric fan 30a is tuned ON, the charger 10 starts power supply to the electric fan 30a according to the power supply related signal (step S122). In this case, the control circuit 24 performs a constant voltage control to the electric fan 30a. Then, if the switch 33 of the electric fan 30a is turned OFF, an abnormality occurs in the electric fan 30a in terms of the voltage, the current, or the temperature, or the predetermined time period has elapsed from the start of the power supply (S123: YES), the charger 10 stops the power supply to the electric fan 30a (step S124).

On the other hand, if any one of turning off the switch 33 of the electric fan 30a, the abnormal condition related to the voltage, the current, or the temperature of the electric fan 30a; or the elapse of the predetermined time period does not happen (S123: NO), the process advances to 5125. In Step 5125, if any operating condition such as air volume, or operating time period has been changed (S125: YES), the control circuit 24 changes the corresponding condition such as the output voltage value, or the current value for the constant voltage control (Step S126). Then, the monitoring the operating condition of the electric fan 30a is maintained (Step S123). If the operating condition is not changed (S125: NO), the power supply from the charger 10 to the electric fan 30a with the current operating condition is maintained. And, the monitoring the operating condition of the electric device 30 is maintained (Step S123).

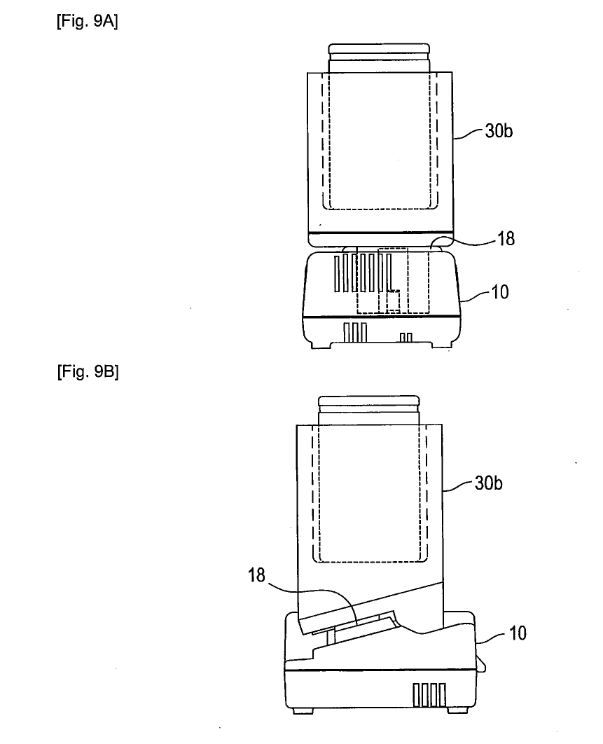

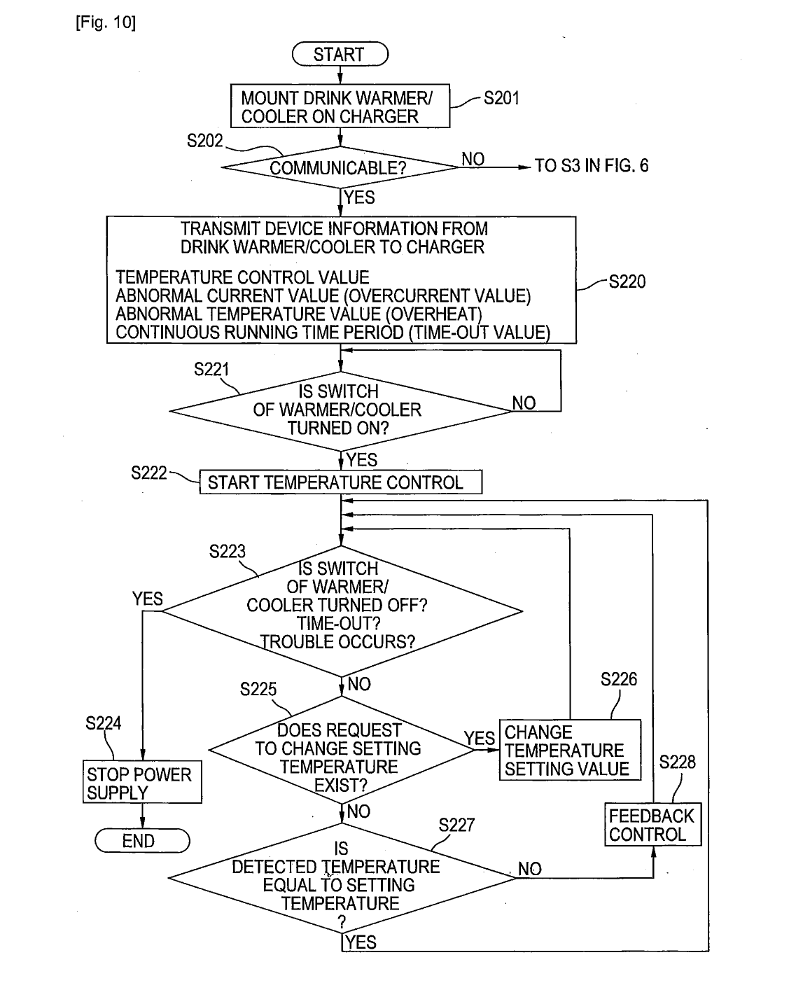

The next description will be made for explaining the operation of the charger 10 when a canned drink cooler/warmer 30b (designated as a cooler/warmer hereinafter) as the electric device is connected to the charger 10, referring to FIGS. 9 and 10. Generally, there are two types of cooler/warmer; one type is a cooler/warmer 30b which is connectable with the plug-in type of charger 10, as shown in FIG. 9A, the other type is a cooler/warmer 30b which is connectable with the slide type of charger 10, as shown in FIG. 9B. A difference between the two types of cooler/warmer is the structure of the connection portion 18. Both of the two types of cooler/warmer have the same operation.

The cooler/warmer 30b is connected to the connection portion 18 of the charger 10 (step S201). In step S202, the control circuit 24 of the charger 10 determines whether the control circuit 24 establishes communication with the cooler/warmer. In other words, if the control circuit 24 of the charger 10 receives a device signal from the cooler/warmer 30b within a predetermined time period from the finishing mounting the cooler/warmer 30b onto the connection portion 18, the control circuit 24 acknowledges that the communication with the cooler/warmer 30b is established (S202: YES), and then determines that the cooler/warmer 30b is connected to the charger 10. In case that the control circuit 24 fails to establish the communication with the cooler/warmer 30b (S202: NO), this phenomenon means that the cooler/warmer 30b might be broken or the battery pack might be connected to the charger 10. Accordingly, if the communication is not established (S202: NO), the procedure advances to Step S3 of the charge process.

The device signal received from the cooler/warmer 30b includes a power supply related signal generated from the control circuit 32 of the cooler/warmer 30b. The power supply related signal may include a temperature control value, an abnormal current value (an overcurrent value), an abnormal temperature value (overheat), or a continuous operating time period (a time-out value). In Step 220, the control circuit 24 of the charger 10 communicates with the cooler/warmer 30b mutually, and then the control circuit 24 controls the charge circuit 12 on the basis of the power supply related signal received from the cooler/warmer 30b. If the charger 10 outputs charger information such as a maximum output current or a maximum output voltage to the cooler/warmer 30b, the cooler/warmer 30b may modify the power supply related signal in accordance with the received charger information and then supply the modified power supply related signal to the charger 10. In this case, the cooler/warmer 30b can maximize the performance of the charger 10.

Then, in step S221, when the switch 33 of the cooler/warmer 30b is tuned ON, the charger 10 starts power supply to the cooler/warmer 30b according to the power supply related signal (step S222). In this case, the cooler/warmer 30b warms up or cools down a canned drink in accordance with the temperature control value by power supply from the charger 10. Then, if the switch 33 of the cooler/warmer 30b is turned OFF, an abnormality occurs in the cooler/warmer 30b in terms of the voltage, the current, or the temperature, or the predetermined time period has elapsed from the start of the power supply (S223: YES), the charger 10 stops the power supply to the cooler/warmer 30b (step S224).

On the other hand, if any one of turning off the switch 33 of the cooler/warmer 30b; the abnormal condition related to the voltage, the current, or the temperature of the cooler/warmer 30b; or the elapse of the predetermined time period does not happen (S223: NO), the process advances to S225. In Step S225, if any operating condition such as the temperature control value, or operating time period has been changed (S225: YES), the control circuit 24 changes the corresponding condition such as the output voltage value, or the current value for the changed temperature setting value (Step S226). Then, the monitoring the operating condition of the cooler/warmer 30b is maintained (Step S223). If the operating condition is not changed (S225: NO), the procedure advances to the Step 5227 where the determination is made as to whether the detected temperature equals to the setting temperature or not. If the detected temperature does not equal to the setting temperature (S227: NO), the feedback control for the cooler/warmer 30b is performed in order that the detected temperature becomes equal to the setting temperature (Step S228). And, the monitoring the operating condition of the electric device 30 is maintained (Step S223). If the detected temperature equals to the setting temperature (S227: YES), the monitoring the operating condition of the electric device 30 is maintained (Step S223).

As described above, the charger 10 is connectable to the electric fan 30a or the cooler/warmer 30b to supply power to the electric fan 30a or the cooler/warmer 30b through the connection portion 18 used for charging the battery pack 100. Thus, the applications of the charger 10 can be diversified, when the charger 10 is not used for charging the battery pack 100.

The electric device 30 which the charger 10 supplies power to is not limited to the above-described devices. The charger according to the present invention can supply power any type of electric device which is connectable to the charger.

The charger of the present invention is not limited to the above embodiment but may be variously modified without departing from the scope of the invention.

The present invention may be applied not only to the charging of the battery pack but also to so-called a multifunctional charger capable of supplying power to a small-sized electric device such as a can cooler/warmer, an electric fan, a mosquito repellent, a lighting device, or a radio.

1. A charger comprising a single connection portion configured to selectively connect either one of a battery pack and an electric device as an object device.

2. The charger according to claim 1, further comprising:
a determination unit configured to determine which the battery pack or the electric device is the object device which is connected to the connection portion; and
a control unit configured to charge the batter pack through the connection portion when the battery pack is connected to the connection portion, the control unit being configured to control power supply to the electric device through the connection portion when the electric device is connected to the connection portion.

3. The charger according to claim 2, characterized in that the electric device is configured to generate a power supply related signal related to power supply thereto; and
the control unit is configured to control power supply to the electric device through the connection portion in accordance with the power supply related signal when the electric device is connected to the connection portion.

4. The charger according to claim 2, characterized in that the determination unit determines whether the object device is able to communicate with the control unit,
when the object device is communicable with the control unit, the determination unit determines that the electric device is connected to the connection portion, and when the object device is not communicable with the control unit, the determination unit determines that the battery pack is connected to the connection portion.

5. The charger according to claim 4, characterized in that the determination unit determines that the object device is communicable with the control unit when the control unit receives device information from the object device.

6. The charger according to claim 3, characterized in that the control unit is configured to transmit charger information to the electric device and the control unit is configured to receive the power supply related signal which has been modified in accordance with the charger information by the electric device.

7. A power supply system comprising:
an electric device having a predetermine function; and
a charger configured to supply power a battery pack and an electric device selectively, the charge comprising a single connection portion configured to selectively connect either one of a battery pack and an electric device as an object device.

8. The power supply system according to claim 7, characterized in that the charger further comprises:
a determination unit configured to determine which the battery pack or the electric device is the object device;
a control unit configured to charge the battery pack through the connection portion when the battery pack is connected to the connection portion, the control unit being configured to control power supply to the electric device through the connection portion when the electric device is connected to the connection portion.

9. The power supply system according to claim 8, characterized in that the electric device is configured to generate a power supply related signal related to power supply thereto; the control unit is configured to control power supply to the electric device through the connection portion in accordance with the power supply related signal when the electric device is connected to the connection portion.

10. The power supply system according to claim 8, characterized in that the determination unit determines whether the object device is able to communicate with the control unit,
when the object device is communicable with the control unit, the determination unit determines that the electric device is connected to the connection portion, and when the object device is not communicable with the control unit, the determination unit determines that the battery pack is connected to the connection portion.

11. The power supply system according to claim 10, characterized in that the determination unit determines that the object device is communicable with the control unit when the control unit receives device information from the object device.

12. The power supply system according to claim 9, characterized in that the control unit is configured to transmit charger information to the electric device, and the electric device modifies the power supply related signal in accordance with the charger information and then transmits the modified power supply related signal to the charger.
